(19) United States
(12) Patent Application Publication
(10) Pub. No.: US 2012/0098712 A1
(43) Pub. Date: Apr. 26, 2012

(54) PORTABLE WIRELESS TERMINAL

(75) Inventors: Kyoko Ishibana, Tokyo (JP); Yoshio Koyanagi, Kanagawa (JP); Yoshihiro Kanasaki, Ishikawa (JP)

(73) Assignee: PANASONIC CORPORATION, Osaka (JP)

(21) Appl. No.: 13/379,876

(22) PCT Filed: Jun. 23, 2010
(86) PCT No.: PCT/JP2010/004185

§ 371 Date: Dec. 21, 2011

(30) Foreign Application Priority Data
Jun. 23, 2009 (JP) 2009-148898

(51) Int. Cl. H01Q 1/24

(52) U.S. Cl. 343/702

(57) ABSTRACT

Disclosed is a portable wireless terminal wherein deterioration in antenna performance when placed on a metal desk or other structure can be prevented without sacrificing designability and without increasing the number of components. In this terminal, a hinge part (103) functions as an antenna which resonates at a frequency of a first wireless system (150). A whip antenna (112) faces the surface of a first circuit board (104) that is opposite the surface faced by an input device (115), is disposed substantially parallel to the first circuit board (104), and resonates at a frequency of a second wireless system (160). A second contact spring (110) electrically connects a second wireless circuit (108) to the antenna element of a whip antenna (112) and is disposed perpendicularly to the first circuit board (104). A switch (113) grounds the whip antenna (112) and second contact spring (110) to the first circuit board (104) when the second wireless system (160) is not operating.

### TECHNICAL FIELD

The present invention relates to a portable wireless terminal having a plurality of wireless systems using frequencies different from each other in particular.

### BACKGROUND ART

Conventionally, a portable wireless terminal having a clamshell casing with a hinge section and using the hinge section as an antenna is known. When such portable wireless terminal is placed on a metal desk such as a steel desk to wait for incoming calls, the antenna comes into close proximity to the metal desk, and the portable wireless terminal and the metal desk are coupled with each other, so that a current having a phase opposite to the antenna current flows on the metal surface of the metal desk. As a result, conventionally, there is a problem in that the radiation directional characteristics of the antenna are changed, and VSWR (Voltage Standing Wave Ratio) characteristics are greatly changed, so that the matching state of the antenna is lost, and the radiation gain decreases.

Conventionally, as a method for solving this problem, a portable radio achieving high reception sensitivity is known. In this portable radio, a rib is provided on the back surface of the portable radio, so that the rib increases the distance between the metal desk and the antenna of the portable radio (for example, see Patent Literature 1).

On the other hand, a portable radio having a high reception sensitivity is known, in which a radiation element and an auxiliary base plate provided on the portable radio are electrically connected to a circuit substrate of the portable radio, so that when the portable radio is placed on the metal desk, an electric field perpendicular to the desk is radiated (for example, see Patent Literature 2).

### CITATION LIST

### Patent Literature

### PTL 1

Japanese Patent Laid-Open No. 10-126304

### PTL 2

Japanese Patent Laid-Open No. 2007-329962

### SUMMARY OF INVENTION

### Technical Problem

However, in the Patent Literature 1, the thickness of the casing increases due to the rib provided thereon, and it is difficult to make the casing thinner. Moreover, since the rib protrudes from the casing, there is a problem in that the design is sacrificed. On the other hand, in Patent Literature 2, it is necessary to newly arrange the radiation element and the auxiliary base plate. Therefore, the number of components increases, and accordingly, the production cost increases. Moreover, it is necessary to have a space in the casing to accommodate the radiation element and the auxiliary base plate, which makes it difficult to reduce the size and make the portable radio thinner.

An object of the present invention is to provide a portable wireless terminal capable of preventing degradation of the antenna performance when the portable wireless terminal is placed on the metal desk and the like, without sacrificing the design and without increasing the number of components.

### Solution to Problem

A portable wireless terminal according to the present invention has a plurality of wireless systems using frequencies different from each other, wherein the portable wireless terminal includes a casing, a circuit substrate that is provided within the casing, a first wireless circuit that is provided on the circuit substrate, a second wireless circuit that is provided on the circuit substrate, an input apparatus that is provided on the casing and arranged to face the circuit substrate, a first antenna that is provided within the casing and is electrically connected to the first wireless circuit, so that the first antenna resonates at a frequency of the first wireless system, a second antenna that is arranged to face a surface of the circuit substrate at a side opposite to a surface thereof facing the input apparatus and arranged substantially parallel to the circuit substrate, wherein the second antenna is electrically connected to the second wireless circuit, so that the second antenna resonates at a frequency of the second wireless system, a connection section that is electrically connected to the second wireless circuit and the second antenna and that has conductivity, wherein the connection section is arranged substantially perpendicular to the surface at the opposite side, and a first grounding section that grounds the second antenna and the connection section to the circuit substrate when the second wireless system is not operating.

### Advantageous Effects of the Invention

Degradation of the antenna performance can be prevented when the portable wireless terminal according to the present invention is placed on the metal desk and the like, without sacrificing the design and without increasing the number of components.

### BRIEF DESCRIPTION OF THE DRAWINGS

FIG. 1 is a plan view illustrating an essential portion of a portable wireless terminal according to Embodiment 1 of the present invention;

FIG. 2 is a side view illustrating the portable wireless terminal according to Embodiment 1 of the present invention;

FIG. 3 is a plan view illustrating an essential portion of a portable wireless terminal according to Embodiment 2 of the present invention;

FIG. 4 is a plan view illustrating an essential portion of a portable wireless terminal according to Embodiment 3 of the present invention;

FIG. 5 is a figure illustrating frequency characteristics of a first trap circuit according to Embodiment 3 of the present invention;

FIG. 6 is a figure illustrating frequency characteristics of a second trap circuit according to Embodiment 3 of the present invention;

FIG. 7 is a plan view illustrating an essential portion of a portable wireless terminal according to Embodiment 4 of the present invention;

FIG. 8 is a plan view illustrating an essential portion of a portable wireless terminal according to Embodiment 5 of the present invention; and

FIG. 9 is a plan view illustrating an essential portion of a portable wireless terminal according to Embodiment 6 of the present invention.

### DESCRIPTION OF EMBODIMENTS

Embodiments of the present invention will be hereinafter explained in detail with reference to the drawings.

### Embodiment 1

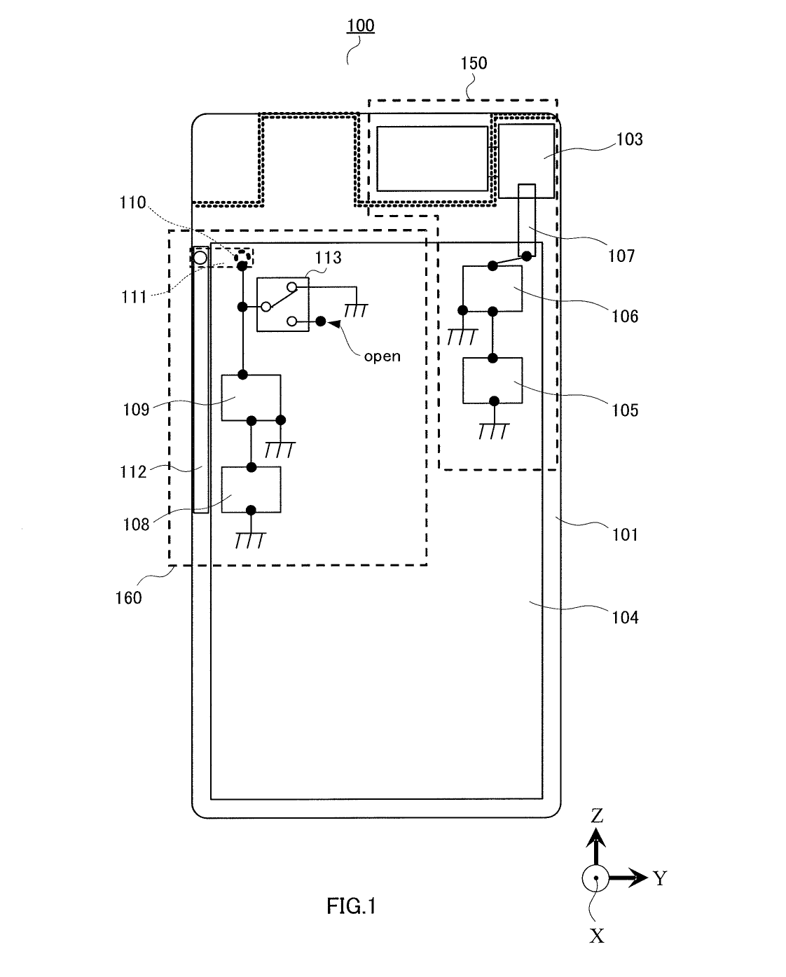

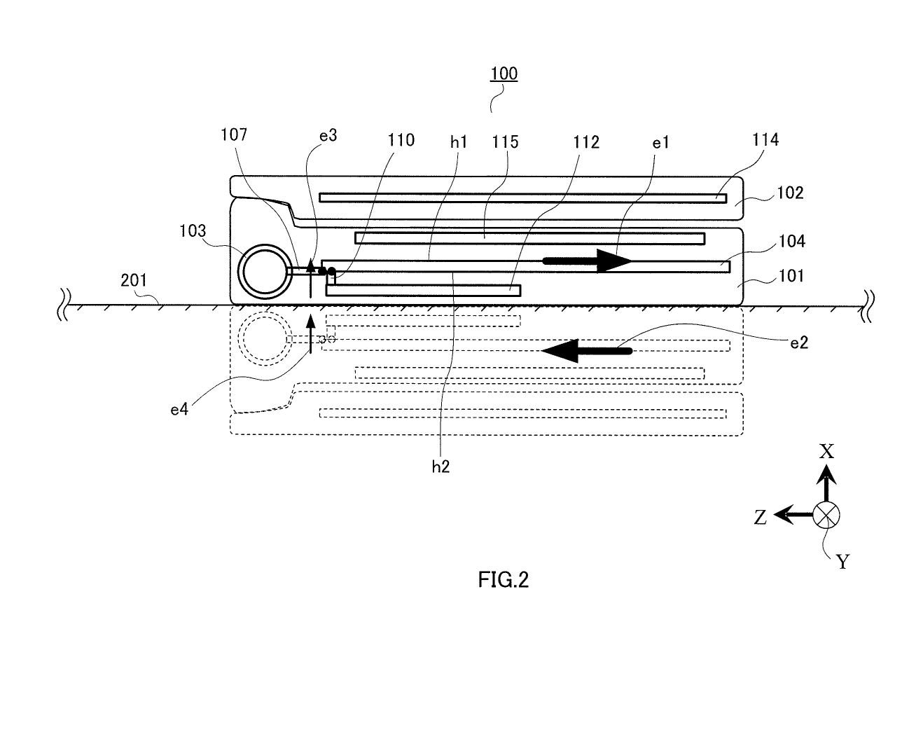

FIG. 1 is a plan view illustrating an essential portion of portable wireless terminal 100 according to Embodiment 1 of the present invention. FIG. 2 is a side view illustrating portable wireless terminal 100 according to Embodiment 1 of the present invention when portable wireless terminal 100 is closed.

Portable wireless terminal 100 includes first casing 101, second casing 102, hinge section 103, first circuit substrate 104, first wireless circuit 105, first matching circuit 106, first contact spring 107, second wireless circuit 108, second matching circuit 109, second contact spring 110, coupling section 111, whip antenna 112, switch 113, second circuit substrate 114, and input device 115. First wireless system 150 is constituted by first wireless circuit 105, first matching circuit 106, first contact spring 107, and metal rotation shaft 116. Second wireless system 160 is constituted by second wireless circuit 108, second matching circuit 109, second contact spring 110, coupling section 111, and whip antenna 112. Each configuration will be hereinafter explained in detail.

First casing 101 is pivotably coupled with second casing 102 by means of hinge section 103. First casing 101 has first circuit substrate 104, whip antenna 112, and input device 115.

Second casing 102 is pivotably coupled with first casing 101 by means of hinge section 103. Second casing 102 has second circuit substrate 114.

Metal rotation shaft 116 is formed with a conductive material, and serves as a rotation shaft for allowing first casing 101 and second casing 102 to pivot. Metal rotation shaft 116 is oscillated by first wireless circuit 105 via first matching circuit 106 and first contact spring 107. As a result, metal rotation shaft 116 resonates at a frequency used by first wireless system 150, and functions as an antenna of first wireless system 150.

First circuit substrate 104 is provided in first casing 101. First circuit substrate 104 includes first wireless circuit 105, first matching circuit 106, first contact spring 107, second wireless circuit 108, second matching circuit 109, second contact spring 110, and switch 113. First circuit substrate 104 has a ground section, not shown, on substantially the entire surface. The ground section is printed and formed on, for example, first circuit substrate 104. First circuit substrate 104 is arranged to face input device 115.

First wireless circuit 105 is provided on first circuit substrate 104, and is electrically connected to first matching circuit 106. In first wireless circuit 105, the ground section is grounded to first circuit substrate 104. First wireless circuit 105 oscillates metal rotation shaft 116 via first matching circuit 106 and first contact spring 107, thus causing metal rotation shaft 116 to function as an antenna. First wireless circuit 105 processes signals transmitted and received by first wireless system 150.

First matching circuit 106 is arranged in series between first wireless circuit 105 and first contact spring 107, so that first matching circuit 106 electrically connects first wireless circuit 105 and first contact spring 107. First matching circuit 106 matches the impedance of metal rotation shaft 116 and the input impedance of first wireless circuit 105.

First contact spring 107 is formed with a spring member, and electrically connects first matching circuit 106 and hinge section 103.

Second wireless circuit 108 is provided on first circuit substrate 104, and is electrically connected to second matching circuit 109. In second wireless circuit 108, the ground section is grounded to circuit substrate 104. Second wireless circuit 108 oscillates whip antenna 112 via second matching circuit 109, second contact spring 110, and coupling section 111. Second wireless circuit 108 processes signals transmitted and received by second wireless system 160.

Second matching circuit 109 is arranged in series between second wireless circuit 108 and second contact spring 110, so that second matching circuit 109 electrically connects second wireless circuit 108 and second contact spring 110. Second matching circuit 109 matches the impedance of whip antenna 112 and the input impedance of second wireless circuit 108.

Second contact spring 110 is formed with a conductive material, and electrically connects second matching circuit 109 and coupling section 111. As shown in FIG. 2, second contact spring 110 is provided in first casing 101 such that at a surface of first circuit substrate 104 opposite to a surface thereof arranged with the input device 115 (a surface at a side in the opposite direction to X direction of FIG. 2), second contact spring 110 faces the surface of first circuit substrate 104 (h2 of FIG. 2) opposite to the surface thereof (h1 of FIG. 2) that faces input device 115, and such that second contact spring 110 is substantially perpendicular to first circuit substrate 104. Second contact spring 110 is arranged on first casing 101 such that second contact spring 110 is substantially perpendicular to a longitudinal direction of whip antenna 112 (Z direction and the opposite direction to Z direction of FIG. 2).

Coupling section 111 is formed with a conductive material, and electrically connects second contact spring 110 and whip antenna 112.

Whip antenna 112 is in a bar shape, and is provided in first casing 101 in such a manner that whip antenna 112 can extend from first casing 101. When whip antenna 112 is retracted, whip antenna 112 is arranged at the surface of first circuit substrate 104 opposite to the surface thereof facing input device 115 (the surface at the side in the opposite direction to X direction of FIG. 2). Whip antenna 112 is provided in first casing 101 so that antenna 112 is substantially parallel to first circuit substrate 104, and whip antenna 112 is provided in first casing 101 so that whip antenna 112 is substantially perpendicular to second contact spring 110. Whip antenna 112 is oscillated by second wireless circuit 108 via second matching circuit 109, second contact spring 110, and coupling section 111. As a result, whip antenna 112 resonates at a frequency used by second wireless system 160, and functions as an antenna of second wireless system 160.

Switch 113 is grounded and connected in parallel between second contact spring 110 and second matching circuit 109. Switch 113 is switched as follows. When second wireless system 160 is not used, switch 113 grounds whip antenna 112, coupling section 111, and second contact spring 110 to first circuit substrate 104. On the other hand, when second wireless system 160 is used, switch 113 is opened to make the impedance infinite.

Second circuit substrate 114 is provided in second casing 102.

Input device 115 is an input device such as a touch panel or operation keys. Input device 115 is arranged to face first circuit substrate 104.

The configuration of portable wireless terminal 100 has been hereinabove explained.

Subsequently, a current distribution in portable wireless terminal 100 will be explained with reference to FIG. 2. FIG. 2 illustrates portable wireless terminal 100 when portable wireless terminal 100 is placed on metal desk 201. In FIG. 2, second wireless system 160 is not used.

In the state of FIG. 2, metal rotation shaft 116 functions as the antenna of first wireless system 150, and accordingly, current distribution e1 is generated in first circuit substrate 104 in the opposite direction to Z direction of FIG. 2. Current distribution e1 is parallel to the surface of desk 201.

Image current e2 flows in desk 201 in Z direction of FIG. 2, i.e., opposite direction to current distribution e1. Therefore, image current e2 acts to cancel current distribution e1, so that current distribution e1 is weakened.

On the other hand, whip antenna 112 is arranged in proximity to desk 201 in parallel to desk 201. Therefore, whip antenna 112 and desk 201 are capacitively coupled with each other in a frequency band of first wireless system 150. At this occasion, whip antenna 112 is grounded to first circuit substrate 104 as a result of switch 113, and current distribution e3 of a high-frequency current of first wireless system 150 is generated in second contact spring 110 in X direction of FIG. 2. Image current e4 flows in desk 201 in the upward direction of FIG. 2, i.e., the same direction as current distribution e3.

According to the above configuration, current distribution e3 generated in second contact spring 110 is not cancelled by desk 201 when portable wireless terminal 100 is placed on desk 201. Therefore, this can prevent degradation of the antenna performance of first wireless system 150. By adjusting the length of whip antenna 112 retracted in first casing 101, the antenna performance of first wireless system 150 can be adjusted. By adjusting the impedance of a frequency higher than the frequency of first wireless system 150, the antenna performance at the frequency of first wireless system 150 can be optimized when portable wireless terminal 100 is placed on desk 201.

In this case, in the present embodiment, for example, first wireless system 150 is a cellular communication system, and second wireless system 160 is a digital television broadcast system. In this case, the frequency band used in first wireless system 150 is 800 MHz to 2170 MHz, and the frequency used by second wireless system 160 is 470 MHz to 770 MHz.

As described above, according to the Embodiment, the degradation of the antenna performance can be prevented when portable wireless terminal 100 is placed on the metal desk and the like, without sacrificing the design. According to the present embodiment, the degradation of the antenna performance of the first wireless system is prevented by using the whip antenna used for the second wireless system. Therefore, no dedicated component is required, and the number of components is reduced. Accordingly, this can prevent the production cost from increasing, and eliminates the necessity of space accommodating the dedicated component. The size of the portable wireless terminal can be reduced, and the portable wireless terminal can be made thinner. According to the present embodiment, the degradation of the antenna performance of the first wireless system is prevented by using a bar-shaped whip antenna. Therefore, the size of area in which the desk and the whip antenna face each other can be increased, and the desk and the whip antenna can be rigidly, capacitively coupled with each other. As a result, the strength of the antenna current flowing in the direction perpendicular to the desk can be obtained sufficiently.

### Embodiment 2

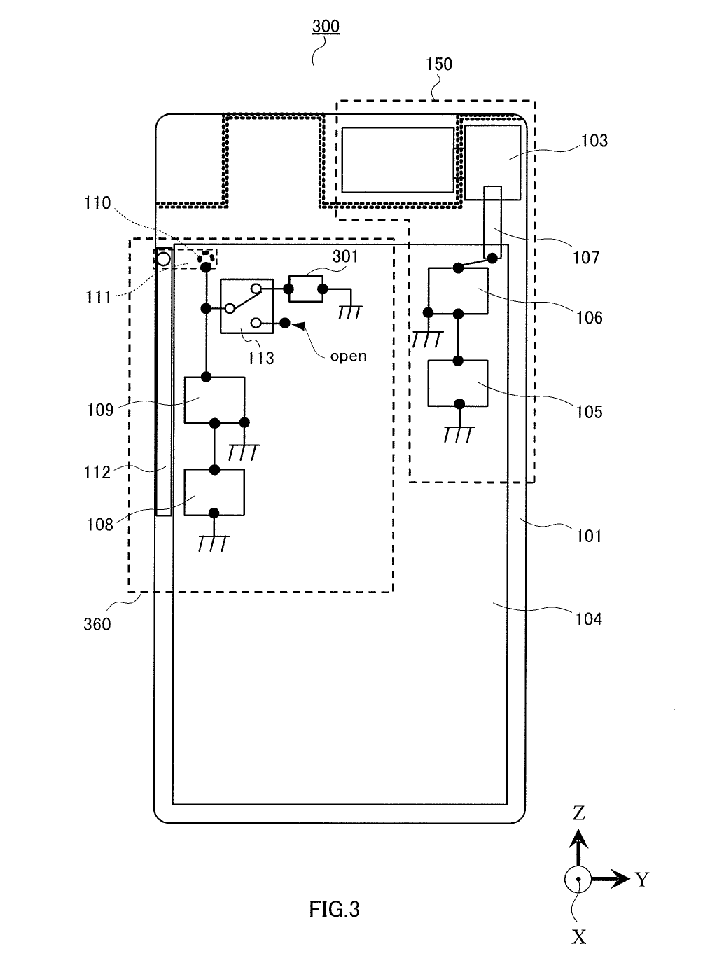

FIG. 3 is a plan view illustrating an essential portion of portable wireless terminal 300 according to Embodiment 2 of the present invention.

Portable wireless terminal 300 shown in FIG. 3 includes reactance circuit 301 in addition to portable wireless terminal 100 according to Embodiment 1 shown in FIG. 1. In FIG. 3, portions having the same configurations as those of FIG. 1 are denoted with the same reference numerals, and description there about is omitted. The side view of portable wireless terminal 300 is the same as that of FIG. 2 except that portable wireless terminal 300 has reactance circuit 301, and therefore, description thereabout is omitted.

Portable wireless terminal 300 includes first casing 101, second casing 102, hinge section 103, first circuit substrate 104, first wireless circuit 105, first matching circuit 106, first contact spring 107, second wireless circuit 108, second matching circuit 109, second contact spring 110, coupling section 111, whip antenna 112, switch 113, second circuit substrate 114, input device 115, and reactance circuit 301. Second wireless system 360 is constituted by second wireless circuit 108, second matching circuit 109, second contact spring 110, coupling section 111, whip antenna 112, and reactance circuit 301. Each configuration of the present embodiment different from Embodiment 1 will be hereinafter explained in detail.

First circuit substrate 104 is provided in first casing 101. First circuit substrate 104 includes first wireless circuit 105, first matching circuit 106, first contact spring 107, second wireless circuit 108, second matching circuit 109, second contact spring 110, coupling section 111, switch 113, and reactance circuit 301. First circuit substrate 104 has a ground section, not shown, on substantially the entire surface. The ground section is printed and formed on, for example, first circuit substrate 104. First circuit substrate 104 is arranged to face input device 115.

Switch 113 is connected in parallel between second contact spring 110 and second matching circuit 109, and is grounded and connected via reactance circuit 301. Switch 113 is switched as follows. When second wireless system 360 is not used, switch 113 grounds whip antenna 112, coupling section 111, and second contact spring 110 to first circuit substrate 104 via reactance circuit 301. On the other hand, when second wireless system 360 is used, switch 113 is opened to make the impedance infinite.

Reactance circuit 301 is connected in series between switch 113 and the ground section, not shown, of first circuit substrate 104, and is grounded and connected in parallel between second contact spring 110 and second matching circuit 109. Reactance circuit 301 adjusts the condition of grounding of whip antenna 112 by adjusting the reactance component of the ground resistance of whip antenna 112.

In this case, in the present embodiment, for example, first wireless system 150 is a cellular communication system, and second wireless system 360 is a digital television broadcast system. In this case, the frequency band used in first wireless system 150 is 800 MHz to 2170 MHz, and the frequency used by second wireless system 160 is 470 MHz to 770 MHz.

When portable wireless terminal 300 is placed on the metal desk, the current distribution is the same as that of Embodiment 1 explained above. Therefore, description thereabout is omitted.

As described above, the present embodiment achieves the effects of Embodiment 1 explained above, and in addition, the whip antenna is grounded via the reactance circuit. This eliminates the necessity of adjusting the length of the whip antenna retracted in the first casing, and allows easy adjustment of the antenna performance of first wireless system 150.

### Embodiment 3

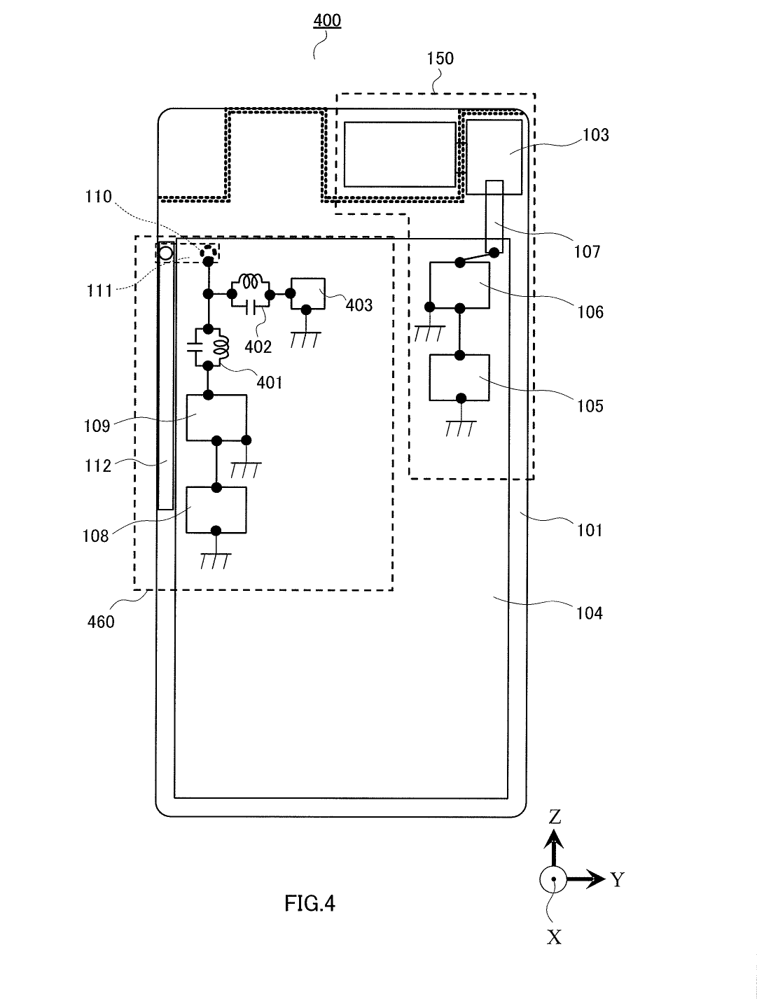

FIG. 4 is a plan view illustrating an essential portion of portable wireless terminal 400 according to Embodiment 3 of the present invention.

Portable wireless terminal 400 as shown in FIG. 4 is different from portable wireless terminal 100 according to Embodiment 1 as shown in FIG. 1 in that portable wireless terminal 400 does not have switch 113 but additionally includes first trap circuit 401, second trap circuit 402, and reactance circuit 403. In FIG. 4, portions having the same configurations as those of FIG. 1 are denoted with the same reference numerals, and description there about is omitted. The side view of portable wireless terminal 400 is the same as that of FIG. 2 except that portable wireless terminal 400 has first trap circuit 401, second trap circuit 402, and reactance circuit 403, and therefore, description thereabout is omitted.

Portable wireless terminal 400 includes first casing 101, second casing 102, hinge section 103, first circuit substrate 104, first wireless circuit 105, first matching circuit 106, first contact spring 107, second wireless circuit 108, second matching circuit 109, second contact spring 110, coupling section 111, whip antenna 112, second circuit substrate 114, input device 115, first trap circuit 401, second trap circuit 402, and reactance circuit 403. Second wireless system 460 is constituted by second wireless circuit 108, second matching circuit 109, second contact spring 110, coupling section 111, whip antenna 112, first trap circuit 401, second trap circuit 402, and reactance circuit 403. Each configuration of the present embodiment different from Embodiment 1 will be hereinafter explained in detail.

First circuit substrate 104 is provided in first casing 101. First circuit substrate 104 includes first wireless circuit 105, first matching circuit 106, first contact spring 107, second wireless circuit 108, second matching circuit 109, second contact spring 110, coupling section 111, first trap circuit 401, second trap circuit 402, and reactance circuit 403. First circuit substrate 104 has a ground section, not shown, on substantially the entire surface. The ground section is printed and formed on, for example, first circuit substrate 104. First circuit substrate 104 is arranged to face input device 115.

Second matching circuit 109 is arranged in series between second wireless circuit 108 and first trap circuit 401, so that second matching circuit 109 electrically connects second wireless circuit 108 and first trap circuit 401. Second matching circuit 109 matches the impedance of whip antenna 112 and the input impedance of second wireless circuit 108.

First trap circuit 401 is arranged in series between second matching circuit 109 and second contact spring 110, so that first trap circuit 401 electrically connects second matching circuit 109 and second contact spring 110. First trap circuit 401 cuts off the frequency used by first wireless system 150 and passes the frequency used by second wireless system 460.

Second trap circuit 402 is connected in parallel between second contact spring 110 and first trap circuit 401, and is grounded and connected via reactance circuit 403. Second trap circuit 402 cuts off the frequency used by second wireless system 460 and passes the frequency used by first wireless system 150.

Reactance circuit 403 is connected in series between second trap circuit 402 and first circuit substrate 104, and is grounded and connected in parallel between second contact spring 110 and first trap circuit 401. Reactance circuit 403 adjusts the condition of grounding of whip antenna 112 by adjusting the reactance component of the ground resistance of whip antenna 112.

FIG. 5 is a figure illustrating frequency characteristics of first trap circuit 401. As can be seen from FIG. 5, first trap circuit 401 cuts off first frequency band #501 used by first wireless system 150, and passes second frequency band #502 used by second wireless system 460.

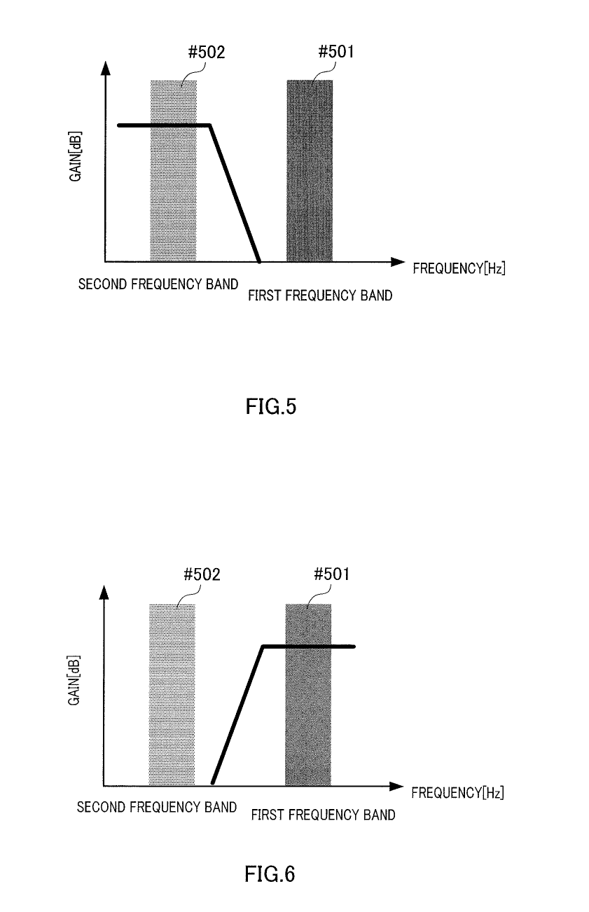

FIG. 6 is a figure illustrating frequency characteristics of second trap circuit 402. As can be seen from FIG. 6, second trap circuit 402 passes first frequency band #501 used by first wireless system 150, and cuts off second frequency band #502 used by second wireless system 460. In this case, in FIGS. 5 and 6, for example, first wireless system 150 is a cellular communication system, and second wireless system 460 is a digital television broadcast system. In this case, the first frequency band is 800 MHz to 2170 MHz, and the second frequency is 470 MHz to 770 MHz.

When portable wireless terminal 400 is placed on the metal desk, the current distribution is the same as that of Embodiment 1 explained above. Therefore, description thereabout is omitted.

As described above, the present embodiment achieves the effects of Embodiment 1 explained above, and in addition, the whip antenna is grounded via the reactance circuit. This allows adjustment of the condition of grounding of the whip antenna without changing the whip antenna retracted in the first casing. The present embodiment eliminates the necessity of the switching control with the switch. As a result, in Embodiment 1 explained above, the whip antenna is not grounded to the first circuit substrate when the second wireless system operates, and therefore, the effect of improving the gain of the antenna of the first wireless system cannot be obtained. In contrast, in the present embodiment, even when the second wireless system and the first wireless system operate at the same time, the effect of improving the gain of the antenna of the first wireless system can be obtained.

### Embodiment 4

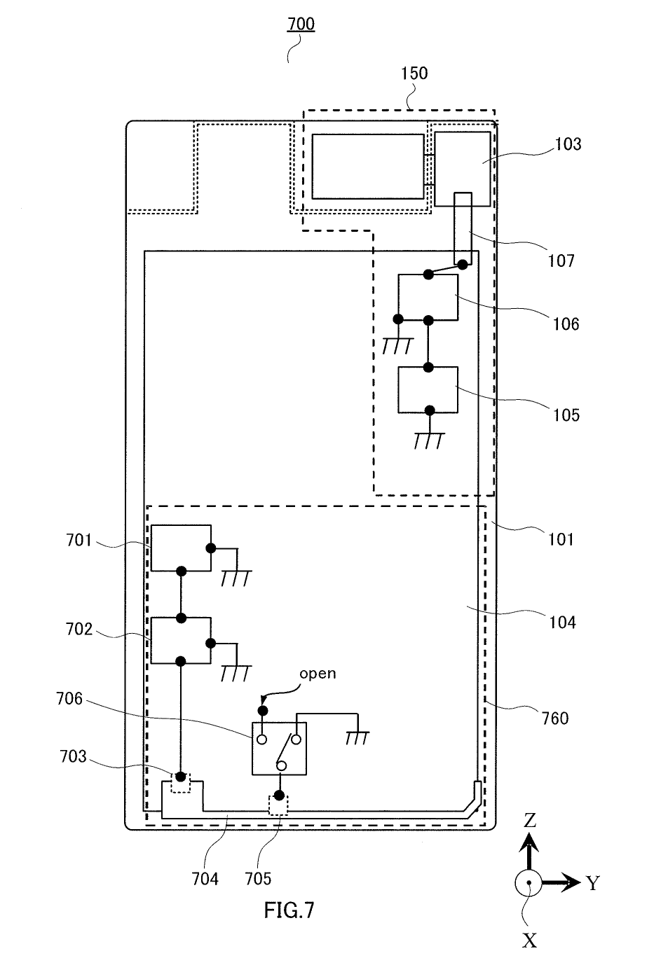

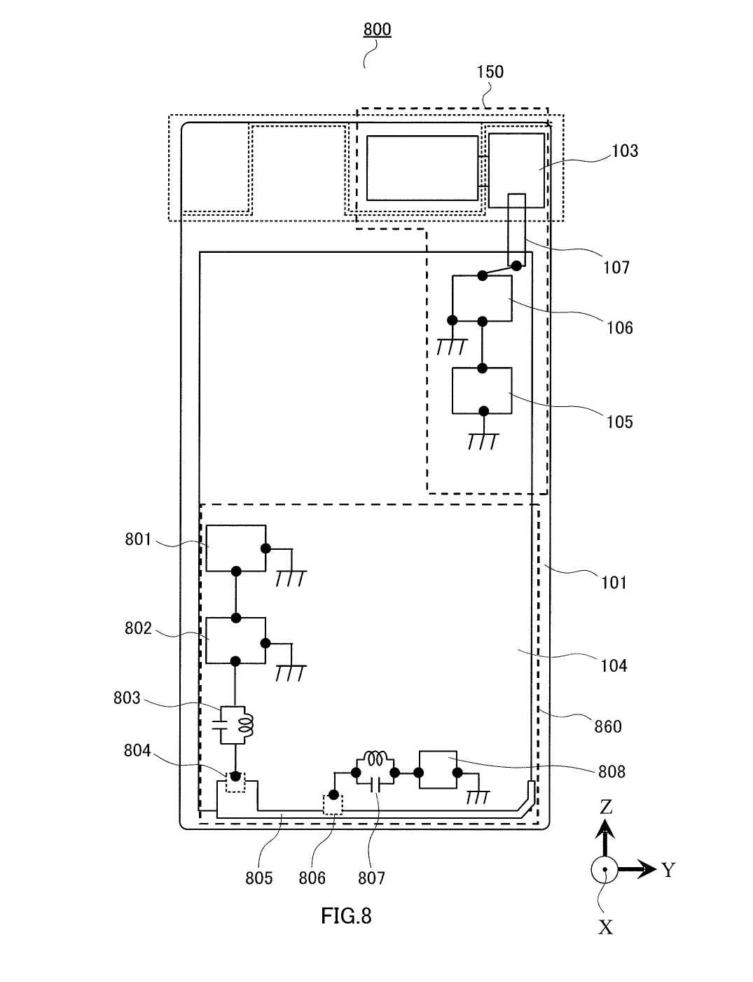

FIG. 7 is a plan view illustrating an essential portion of portable wireless terminal 700 according to Embodiment 4 of the present invention.

Portable wireless terminal 700 shown in FIG. 7 is different from portable wireless terminal 100 according to Embodiment 1 shown in FIG. 1 in that portable wireless terminal 700 does not have coupling section 111 and whip antenna 112, and additionally includes second antenna 704 and third contact spring 705. In addition, portable wireless terminal 700 has second wireless circuit 701 in place of second wireless circuit 108, has second matching circuit 702 in place of second matching circuit 109, has second contact spring 703 in place of second contact spring 110, and has switch 706 in place of switch 113. In FIG. 7, portions having the same configurations as those of FIG. 1 are denoted with the same reference numerals, and description there about is omitted. The side view of portable wireless terminal 700 is the same as that of FIG. 2 except that portable wireless terminal 700 has second antenna 704 and third contact spring 705, and therefore, description thereabout is omitted.

Portable wireless terminal 700 includes first casing 101, second casing 102, hinge section 103, first circuit substrate 104, first wireless circuit 105, first matching circuit 106, first contact spring 107, second circuit substrate 114, input device 115, second wireless circuit 701, second matching circuit 702, second contact spring 703, second antenna 704, third contact spring 705, and switch 706.

Second wireless system 760 is constituted by second wireless circuit 701, second matching circuit 702, second contact spring 703, second antenna 704, third contact spring 705, and switch 706. Second wireless system 760 uses a frequency different from first wireless system 150. Each configuration of the present embodiment different from Embodiment 1 will be hereinafter explained in detail.

First circuit substrate 104 is provided in first casing 101. First circuit substrate 104 includes first wireless circuit 105, first matching circuit 106, first contact spring 107, second wireless circuit 701, second matching circuit 702, second contact spring 703, third contact spring 705, and switch 706. First circuit substrate 104 has a ground section, not shown, on substantially the entire surface. The ground section is printed and formed on, for example, first circuit substrate 104. First circuit substrate 104 is arranged to face input device 115.

Second wireless circuit 701 is provided on first circuit substrate 104, and is electrically connected to second matching circuit 702. In second wireless circuit 701, the ground section is grounded to first circuit substrate 104. Second wireless circuit 701 oscillates second antenna 704 via second matching circuit 702 and second contact spring 703. Second wireless circuit 701 processes signals transmitted and received by second wireless system 760.

Second matching circuit 702 is arranged in series between second wireless circuit 701 and second contact spring 703, so that second matching circuit 702 electrically connects second wireless circuit 702 and second contact spring 703. Second matching circuit 702 matches the impedance of second antenna 704 and the input impedance of second wireless circuit 701.

Second contact spring 703 is formed with a conductive material, and electrically connects second matching circuit 702 and second antenna 704.

Second antenna 704 is made by bending a plate-shaped sheet metal made of a metal material, and is provided at an end portion in −Z direction in first casing 101 (at a lower end portion of first casing 101). Second antenna 704 can adjust the grounding condition by adjusting the position of third contact spring 705. By adjusting the element length, second antenna 704 can be used as an antenna shared by digital television broadcast and Bluetooth.

Third contact spring 705 is provided as a countermeasure against a metal plate such as a metal desk, and is formed with a conductive material. Third contact spring 705 is provided separately from a feeding point of second antenna 704, and is electrically connected to second antenna 704 at a point somewhere in second antenna 704, so that third contact spring 705 electrically connects second antenna 704 and switch 706.

When portable wireless terminal 700 is placed on the metal desk, the current distribution is the same as that of Embodiment 1 explained above. Therefore, description thereabout is omitted.

As described above, the present embodiment achieves the effects of Embodiment 1 explained above, and in addition, the grounding condition of the second antenna can be adjusted by adjusting the position of the third contact spring. Therefore, the condition of grounding of the antenna can be adjusted without changing the element length of the antenna.

### Embodiment 5

FIG. 8 is a plan view illustrating an essential portion of portable wireless terminal 800 according to Embodiment 5 of the present invention.

Portable wireless terminal 800 shown in FIG. 8 is different from portable wireless terminal 100 according to Embodiment 1 shown in FIG. 1 in that portable wireless terminal 800 does not have coupling section 111 and whip antenna 112, and additionally includes first trap circuit 803, second antenna 805, third contact spring 806, second trap circuit 807, and reactance circuit 808. In addition, portable wireless terminal 800 has second wireless circuit 801 in place of second wireless circuit 108, has second matching circuit 802 in place of second matching circuit 109, and has second contact spring 804 in place of second contact spring 110. In FIG. 8, portions having the same configurations as those of FIG. 1 are denoted with the same reference numerals, and description there about is omitted. The side view of portable wireless terminal 800 is the same as that of FIG. 2 except that portable wireless terminal 800 has first trap circuit 803, second antenna 805, third contact spring 806, second trap circuit 807, and reactance circuit 808, and therefore, description thereabout is omitted.

Portable wireless terminal 800 includes first casing 101, second casing 102, hinge section 103, first circuit substrate 104, first wireless circuit 105, first matching circuit 106, first contact spring 107, second circuit substrate 114, input device 115, second wireless circuit 801, second matching circuit 802, first trap circuit 803, second contact spring 804, second antenna 805, third contact spring 806, second trap circuit 807, and reactance circuit 808.

Second wireless system 860 is constituted by second wireless circuit 801, second matching circuit 802, first trap circuit 803, second contact spring 804, second antenna 805, third contact spring 806, second trap circuit 807, and reactance circuit 808. Second wireless system 860 uses a frequency different from first wireless system 150. Each configuration of the present embodiment different from Embodiment 1 will be hereinafter explained in detail.

First circuit substrate 104 is provided in first casing 101. First circuit substrate 104 includes first wireless circuit 105, first matching circuit 106, first contact spring 107, second wireless circuit 801, second matching circuit 802, first trap circuit 803, second contact spring 804, third contact spring 806, second trap circuit 807, and reactance circuit 808. First circuit substrate 104 has a ground section, not shown, on substantially the entire surface. The ground section is printed and formed on, for example, first circuit substrate 104. First circuit substrate 104 is arranged to face input device 115.

Second wireless circuit 801 is provided on first circuit substrate 104, and is electrically connected to second matching circuit 802. In second wireless circuit 801, the ground section is grounded to first circuit substrate 104. Second wireless circuit 801 oscillates second antenna 805 via second matching circuit 802, first trap circuit 803, and second contact spring 804. Second wireless circuit 801 processes signals transmitted and received by second wireless system 860.

Second matching circuit 802 is arranged in series between second wireless circuit 801 and first trap circuit 803, so that second matching circuit 802 electrically connects second wireless circuit 801 and first trap circuit 803. Second matching circuit 802 matches the impedance of second antenna 805 and the input impedance of second wireless circuit 801.

First trap circuit 803 is arranged in series between second matching circuit 802 and second contact spring 804, so that first trap circuit 803 electrically connects second matching circuit 802 and second contact spring 803. First trap circuit 803 cuts off the frequency used by first wireless system 150 and passes the frequency used by second wireless system 860.

Second contact spring 804 is formed with a conductive material, and electrically connects first trap circuit 803 and second antenna 805.

Second antenna 805 is made by bending a plate-shaped sheet metal made of a metal material, and is provided at an end portion in −Z direction in first casing 101 (at a lower end portion of first casing 101). Second antenna 805 can adjust the grounding condition by adjusting the position of third contact spring 806. By adjusting the element length, second antenna 805 can be used as an antenna shared by digital television broadcast and Bluetooth.

Third contact spring 806 is provided as a countermeasure against a metal plate such as a metal desk, and is formed with a conductive material. Third contact spring 806 is provided separately from a feeding point of second antenna 805, and is electrically connected to second antenna 805 at a point somewhere in second antenna 805, so that second antenna 805 electrically connects second antenna 805 and second trap circuit 807.

Second trap circuit 807 is arranged in series between third contact spring 806 and reactance circuit 808, so that second trap circuit 807 electrically connects third contact spring 806 and reactance circuit 808. Second trap circuit 807 cuts off the frequency used by second wireless system 860 and passes the frequency used by first wireless system 150.

Reactance circuit 808 is connected in series between second trap circuit 807 and first circuit substrate 104. Reactance circuit 808 adjusts the condition of grounding of second antenna 805 by adjusting the reactance component of the ground resistance of second antenna 805.

When portable wireless terminal 800 is placed on the metal desk, the current distribution is the same as that of Embodiment 1 explained above. Therefore, description thereabout is omitted.

As described above, the present embodiment achieves the effects of Embodiment 1 explained above, and in addition, the grounding condition of the second antenna can be adjusted by adjusting the position of the third contact spring. Therefore, the condition of grounding of the antenna can be adjusted without changing the element length of the antenna. The present embodiment eliminates the necessity of the switching control with the switch in the same manner as Embodiments 1 to 3 explained above. Therefore, when the second wireless system operates, e.g., when the first wireless system and the second wireless system operate at the same time, the effect of improving the antenna gain of the first wireless system can be obtained as compared with Embodiments 1 to 3 in which the second antenna is not grounded to the first circuit substrate.

### Embodiment 6

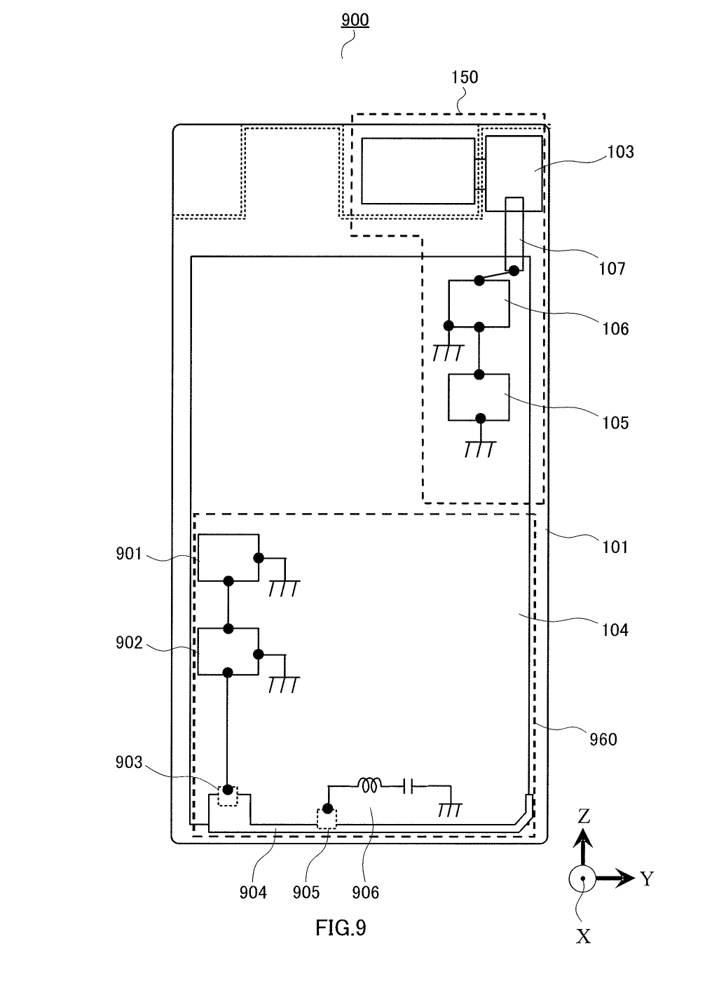

FIG. 9 is a plan view illustrating an essential portion of portable wireless terminal 900 according to Embodiment 6 of the present invention.

Portable wireless terminal 900 shown in FIG. 9 is different from portable wireless terminal 100 according to Embodiment 1 shown in FIG. 1 in that portable wireless terminal 900 does not have coupling section 111 and whip antenna 112, and additionally includes second antenna 904, third contact spring 905, and notch filter 906. In addition, portable wireless terminal 900 has second wireless circuit 901 in place of second wireless circuit 108, has second matching circuit 902 in place of second matching circuit 109, and has second contact spring 903 in place of second contact spring 110. In FIG. 9, portions having the same configurations as those of FIG. 1 are denoted with the same reference numerals, and description there about is omitted. The side view of portable wireless terminal 900 is the same as that of FIG. 2 except that portable wireless terminal 900 has second antenna 904, third contact spring 905, and notch filter 906, and therefore, description thereabout is omitted.

Portable wireless terminal 900 includes first casing 101, second casing 102, hinge section 103, first circuit substrate 104, first wireless circuit 105, first matching circuit 106, first contact spring 107, second circuit substrate 114, input device 115, second wireless circuit 901, second matching circuit 902, second contact spring 903, second antenna 904, third contact spring 905, and notch filter 906.

Second wireless system 960 is constituted by second wireless circuit 901, second matching circuit 902, second contact spring 903, second antenna 904, third contact spring 905, and notch filter 906. Second wireless system 960 uses a frequency different from first wireless system 150. Each configuration of the present embodiment different from Embodiment 1 will be hereinafter explained in detail.

First circuit substrate 104 is provided in first casing 101. First circuit substrate 104 includes first wireless circuit 105, first matching circuit 106, first contact spring 107, second wireless circuit 901, second matching circuit 902, second contact spring 903, third contact spring 905, and notch filter 906. First circuit substrate 104 has a ground section, not shown, on substantially the entire surface. The ground section is printed and formed on, for example, first circuit substrate 104. First circuit substrate 104 is arranged to face input device 115.

Second wireless circuit 901 is provided on first circuit substrate 104, and is electrically connected to second matching circuit 902. In second wireless circuit 901, the ground section is grounded to first circuit substrate 104. Second wireless circuit 901 oscillates second antenna 904 via second matching circuit 902 and second contact spring 903. Second wireless circuit 901 processes signals transmitted and received by second wireless system 960.

Second matching circuit 902 is arranged in series between second wireless circuit 901 and second contact spring 903, so that second matching circuit 902 electrically connects second wireless circuit 901 and second contact spring 903. Second matching circuit 902 matches the impedance of second antenna 904 and the input impedance of second wireless circuit 901.

Second contact spring 903 is formed with a conductive material, and electrically connects second matching circuit 902 and second antenna 904.

Second antenna 904 is made by bending a plate-shaped sheet metal made of a metal material, and is provided at an end portion in −Z direction in first casing 101 (at a lower end portion of first casing 101). Second antenna 904 can adjust the grounding condition by adjusting the position of third contact spring 905. By adjusting the element length, second antenna 904 can be used as an antenna shared by digital television broadcast and Bluetooth.

Third contact spring 905 is provided as a countermeasure against a metal plate such as a metal desk, and is formed with a conductive material. Third contact spring 905 is provided separately from a feeding point of second antenna 904, and is electrically connected to second antenna 904 at a point somewhere in second antenna 904, so that third contact spring 905 electrically connects second antenna 904 and notch filter 906.

Notch filter 906 in arranged in series between third contact spring 905 and first circuit substrate 104, and electrically connects third contact spring 905 and first circuit substrate 104. Notch filter 906 cuts off the frequency used by second wireless system 960 and passes the frequency used by first wireless system 150.

When portable wireless terminal 900 is placed on the metal desk, the current distribution is the same as that of Embodiment 1 explained above. Therefore, description thereabout is omitted.

As described above, the present embodiment achieves the effects of Embodiment 1 explained above, and in addition, the grounding condition of the second antenna can be adjusted by adjusting the position of the third contact spring. Therefore, the condition of grounding of the antenna can be adjusted without changing the element length of the antenna. The present embodiment eliminates the necessity of the switching control with the switch in the same manner as Embodiments 1 to 3 explained above. Therefore, when the second wireless system operates, e.g., when the first wireless system and the second wireless system operate at the same time, the effect of improving the antenna gain of the first wireless system can be obtained as compared with Embodiments 1 to 3 in which the second antenna is not grounded to the first circuit substrate.

In Embodiments 1 to 6 explained above, signals of a plurality of wireless systems using frequencies different from each other are transmitted with the hinge section and the whip antenna or the second antenna. However, the present invention is not limited thereto. Signals of a plurality of wireless systems using frequencies different from each other can be transmitted with a plurality of antennas. In Embodiments 1 to 6 explained above, the antenna capacitively coupled with the desk is the whip antenna or the second antenna. However, the present invention is not limited thereto. Any antenna having a size of area capable of being capacitively coupled with the desk can be used. In Embodiments 1 to 6 explained above, the portable wireless terminal had the clamshell casing. However, the present invention is not limited thereto. The present invention can be applied to any portable wireless terminal having any casing such as slide type or straight type.

All of the contents disclosed in the specification, drawings, and abstract included in the Japanese application of Japanese Patent Application No. 2009-148898 filed on Jun. 23, 2009 are incorporated herein by reference.

### INDUSTRIAL APPLICABILITY

The portable wireless terminal according to the present invention is particularly suitable for incorporating a plurality of wireless systems using frequencies different from each other.

1. A portable wireless terminal having a plurality of wireless systems using frequencies different from each other, the portable wireless terminal comprising:
a casing;
a circuit substrate that is provided within the casing;
a first wireless circuit that is provided on the circuit substrate;
a second wireless circuit that is provided on the circuit substrate;
an input apparatus that is provided on the casing and arranged to face the circuit substrate;
a first antenna that is provided within the casing and is electrically connected to the first wireless circuit, so that the first antenna resonates at a frequency of the first wireless system;
a second antenna that is arranged to face a surface of the circuit substrate at a side opposite to a surface thereof facing the input apparatus and arranged substantially parallel to the circuit substrate, wherein the second antenna is electrically connected to the second wireless circuit, so that the second antenna resonates at a frequency of the second wireless system;
a connection section that is electrically connected to the second wireless circuit and the second antenna and that has conductivity, wherein the connection section is arranged substantially perpendicular to the surface at the opposite side; and
a first grounding section that grounds the second antenna and the connection section to the circuit substrate when the second wireless system is not operating.

2. The portable wireless terminal according to claim 1, further comprising a reactance circuit that is provided on the circuit substrate and that adjusts a ground resistance when the circuit substrate is grounded to the first grounding section.

3. The portable wireless terminal according to claim 1, wherein the first grounding section is a trap circuit that cuts off a frequency used by the second wireless system.

4. The portable wireless terminal according to claim 1, wherein the second antenna is a whip antenna.

5. The portable wireless terminal according to claim 1, wherein a second grounding section is provided on the circuit substrate as a countermeasure against a metal plate, and wherein the second grounding section is electrically connected to the second antenna at a point in the second antenna and provided separately from a feeding point of the second antenna.

6. The portable wireless terminal according to claim 1, wherein the second antenna is arranged at a lower end portion of the casing within the casing.

7. The portable wireless terminal according to claim 1, wherein the second antenna is an antenna shared by digital television broadcast and Bluetooth.
